(19) United States
(12) Patent Application Publication
(10) Pub. No.: US 2025/0096860 A1
(43) Pub. Date: Mar. 20, 2025

(54) METHOD FOR COMMUNICATION BETWEEN AN EMITTER AND A RECEIVER, CORRESPONDING EMITTER, RECEIVER AND COMPUTER PROGRAM

(71) Applicant: Orange, Issy-Les-Moulineaux (FR)

(72) Inventors: Raphaël VISOZ, Chatillon Cedex (FR); Rita IBRAHIM, Chatillon Cedex (FR)

(21) Appl. No.: 18/723,371

(22) PCT Filed: Dec. 20, 2022
(86) PCT No.: PCT/EP2022/086867

§ 371 Date: Jun. 21, 2024

(30) Foreign Application Priority Data
Dec. 23, 2021 (FR) FR2114459

(51) Int. Cl. H04B 7/0456; H04B 17/345; H04B 17/382; H04L 25/02

(52) U.S. Cl. CPC H04B 7/0456; H04B 17/345; H04L 25/021; H04B 17/382; H04L 25/0248

(57) ABSTRACT

A method for communication between an emitter and a receiver, corresponding emitter, receiver and computer program. The development relates to a communication method implemented in a transmission system comprising an emitter and a receiver, the receiver implementing: estimating a covariance matrix of the interference, representative of the spatial structure of the reception interference. According to the development, the receiver further implements: selecting a technique for acquiring knowledge of the emission channel, in a group of techniques comprising a first technique based on a compressed version of the covariance matrix of the interference and at least one second technique, and transmitting to the emitter at least one piece of information relating to the technique for acquiring knowledge of the emission channel selected by the receiver.

### CROSS-REFERENCE TO RELATED APPLICATIONS

This application is filed under 35 U.S.C. § 371 as the U.S. National Phase of Application No. PCT/EP2022/086867 entitled “Method for communication between an emitter and a receiver, corresponding emitter, receiver and computer program” and filed Dec. 20, 2022, and which claims priority to FR 2114459 filed Dec. 23, 2021, each of which is incorporated by reference in its entirety. The development relates to the field of wireless communications.

### BACKGROUND

### Field

The development relates to the field of wireless communications.

More specifically, the development proposes a technique allowing optimizing the formation of beams obtained from an array of antennas, so as to improve the transmission of information between an emitter and a receiver, in the uplink, as well as in the downlink.

The development finds applications in any system based on beamforming, in particular in radio communication networks according to the 4G or 5G standards defined by 3GPP, WiFi communication networks according to the different IEEE 802.11 standards, etc.

For a downlink communication, the emitter may be a base station, for example of the evolved eNodeB (“evolved Node B” in English) type for networks based on the LTE or LTE Advanced technologies, or else a Wi-Fi access point, etc. In turn, a receiver may be a terminal such as a smartphone, a tablet, a connected object, etc. For an uplink communication, the emitter may be a terminal, and the receiver a base station.

### Description of the Related Technology

Beamforming, or pre-coding, is a signal processing technique used in antenna or sensor arrays for the directional emission or reception of signals. In other words, thanks to the antenna arrays, the emitters and/or receivers can focus the radiation of the emitted wave in a particular direction, which allows obtaining a spatial selectivity.

Beamforming is carried out by combining the elements of a phase- and amplitude-controlled antenna array so that:
the signals combine in constructive manner in particular directions, resulting in a reinforcement of the received useful power,
the signals combine in a destructive manner in the other directions, resulting in a decrease in the received interference power.

Thus, for beamforming at an emitter, a complex coefficient, so-called pre-coding coefficient, is applied to each element of the antenna array of the emitter. All these coefficients form a pre-coding matrix.

It should be noted that for the radiation pattern to be oriented in the desired direction, the pre-coding coefficients must be properly selected. The better the selected pre-coding, the better the transmission will be. The fundamental problem for the selection of this pre-coding is the acquisition of knowledge of the emission channel or “Transmit Channel State Information” (CSI). By knowledge of the emission channel, it should be understood, within the meaning of the information theory, the knowledge of the channel in the emitter-to-receiver direction and of the statistics of the reception interference.

Currently, two techniques for acquiring knowledge of the emission channel are proposed for MIMO systems in 4G, 5G, IEEE 802.11x (IEEE 802.11n, 802.11ac, 802.11ax) standards: a technique based on the use of a pre-coding codebook (“codebook”) and a technique based on the reciprocity of the channel (“channel reciprocity”). The techniques for acquiring knowledge of the channel, and the associated reference signals, are described more specifically in the 3GPP TS36.213, TS36.211 specifications for 4G and the TS38.211, TS38.214 specifications for 5G.

The first technique based on the use of a pre-coding codebook, denoted CSI-D, relies on the use of a limited return path between the receiver and the emitter and on the pre-coding codebook (thereby “D” in CSI-D, standing for dictionary).

According to this CSI-D technique, the emitter emits a reference signal, also so-called pilot signal. Such a reference signal is typically denoted CSI-RS in 4G and 5G standards, standing for “Channel State Information-Reference Signal”. Upon reception of the reference signal, the receiver estimates, on the one hand, the transmission channel between the emitter and the receiver (i.e. in the emitter-to-receiver direction), and, on the other hand, a covariance matrix of the interference, representative of the spatial structure of the interference between the receiver antennas.

Based on the estimate of the transmission channel between the emitter and the receiver and the spatial characteristics of the interference, the receiver selects the pre-coding matrix to be used by the emitter in the finished pre-coding codebook. In general, this pre-coding codebook is defined by a standard, like the 4G standard or the 5G standard. Afterwards, the receiver feeds back this pre-coding selection to the emitter via the limited return path, for example in the form of an indicator of the “Pre-coding matrix Indicator” (PMI) type. Optionally, the feedback of the pre-coding selection may be accompanied by an channel quality indicator (or CQI) and/or an indicator of the number of spatial layers (“Rank Indicator”, RI).

Alternatively to the CSI-D technique, it is possible to implement a technique, denoted CSI-R, which relies on the reciprocity of the channel between the emitter and the receiver (thereby R, standing for reciprocity). This reciprocity assumes that the transmission channel between the receiver and the emitter (i.e. in the receiver-to-emitter direction) is the same as the transmission channel between the emitter and the receiver (i.e. in the emitter-to-receiver direction). In this case, the channel includes the effects of the radiofrequency chains which a priori are not reciprocal in emission and reception, but which can be calibrated in order to become so. Thus, the CSI-R technique assumes a use of the same frequency resources and a temporal separation of the uplink and downlink channels, or “Time Division Duplex”, TDD).

According to the CSI-R technique, the receiver emits a reference signal, for example of the SRS type (standing for “Sounding Reference Signal”) in the 4G and 5G standards. From this reference signal, the emitter estimates the transmission channel between the receiver and the emitter (i.e. in the receiver-to-emitter direction) and deduces therefrom by reciprocity the transmission channel between the emitter and the receiver (i.e. in the emitter-to-receiver direction).

According to a first variant, denoted CSI-R1, based on the estimate of the transmission channel between the emitter and the receiver, the emitter can select a pre-coding matrix to be used. For example, the emitter determines a pre-coding matrix according to a criterion for maximizing the signal-to-noise ratio (SNR) or the predicted bit rate, while neglecting the spatial structure of the interference (or covariance of the interference).

According to a second variant, denoted CSI-R2, the receiver estimates a covariance matrix of the interference and returns a compressed version of this covariance matrix of the interference to the emitter. For example, this compressed version may be in the form of the I greatest eigenvalues of the covariance matrix (the latter being a N_{R}×N_{R} dimension matrix, where N_{R} is the number of receiver antennas of the receiver). The covariance matrix of the interference being positive-definite, it is ortho-diagonalizable, and it is easy to deduce its eigenvalues therefrom and to order them.

However, none of these CSI-D, CSI-R1 or CSI-R2 techniques give full satisfaction, each having their drawbacks.

Although it enables the emitter to know the transmission channel without quantization, the CSI-R1 technique does not enable the emitter to know the reception interference. Indeed, such a technique determines the pre-coding matrix to be used while neglecting the spatial structure of the interference, the reception interference not being reciprocal. It is then possible that the emission pre-coding according to the CSI-R technique corresponds to directions where the interference is the strongest.

The feedback of the covariance of the interference of the receiver to the emitter according to this CSI-R1 technique is difficult to consider, since it would be too consuming in quantity of return channel. The pre-coding matrix based on the CSI-R1 is therefore obtained without taking account of the covariance of the interference or, which amounts to the same, by considering it unstructured.

The CSI-D and CSI-R2 techniques (respectively via a predetermined codebook and via a return of a compressed version of the covariance matrix of the interference) enable the emitter to determine only one quantized (therefore approximate) version of the pre-coding to be used. In the case of the CSI-D technique, this pre-coding is derived from a predetermined pre-coding codebook, and in the other case, the CSI-R2 technique, this pre-coding is derived from an approximate version of the covariance matrix of the interference.

Hence, there is a need for a new approach in the acquisition of the knowledge of the emission channel in order to improve the transmission of information between an emitter and a receiver, which does not have the disadvantages that each of the previously-described techniques has.

The development improves the situation.

### SUMMARY

The development provides a solution free of all these drawbacks, in the form of a communication method implemented in a transmission system comprising an emitter and a receiver.

The communication method, implemented at the receiver, is of the type comprising estimating a covariance matrix of the interference, representative of the spatial structure of the reception interference.

This communication method is remarkable in that it further implements:
selecting a technique for acquiring knowledge of the emission channel, in a group of techniques comprising a first technique based on a compressed version of said covariance matrix of the interference and at least one second technique, and
transmitting to said emitter at least one piece of information enabling the emitter to determine a pre-coding matrix taking account of the covariance matrix of the interference according to said technique for acquiring knowledge of the emission channel selected by said receiver.

Thus, this communication method allows simulating the implementation of different techniques for acquiring knowledge of the emission channel, and selecting the technique considered as optimum, for example that one offering the best transmission bit rate for a given error rate.

Next, the expression “piece of information enabling the emitter to determine a pre-coding matrix taking account of the covariance matrix of the reception interference according to a technique for acquiring knowledge of the emission channel” is abbreviated as piece of information relating to such a technique.

The feedback to the emitter of at least one piece of information relating to the technique for acquiring knowledge of the channel selected by the receiver enables the emitter to determine an emission format of the data based on this information, in particular a pre-coding matrix (and possibly a modulation and coding scheme and/or a number of spatial layers to be used in emission), and then to transmit the data using this emission format.

It is also possible to consider the simulation of more than two techniques for acquiring knowledge of the channel in this communication method, thereby conferring flexibility and adaptability thereon.

For example, the first technique is of the CSI-R2 type. Said at least one second technique may be of the CSI-R1, CSI-D, etc., type.

In one embodiment, the selection of a technique for acquiring knowledge of the emission channel comprises the prediction of a transmission parameter associated with each technique of the group of techniques and the selection of the technique for which said transmission parameter meets a first criterion.

For example, the transmission parameter is of the transmission bit rate type, and the first criterion is such that the best bit rate amongst the bit rates obtained by the simulation of the different techniques for acquiring knowledge of the channel.

The selection of a technique based on a transmission parameter (bit rate, error rate, signal-to-noise ratio, or signal-to-noise-plus-interference ratio, etc.) allows improving the quality of the transmission within the transmission system.

In one embodiment, said prediction of the transmission parameter associated with a given technique of the group of techniques comprises:
for each sub-band k of a plurality of frequency sub-bands of the channel between said emitter and said receiver, obtaining a set of pre-coding matrices,
selecting, in each set of pre-coding matrices associated with a sub-band, a pre-coding matrix so that the transmission parameter resulting from this selection meets a second criterion.

For example, the transmission parameter is of the transmission bit rate type, and the second criterion is such that the best bit rate amongst the bit rates obtained by the different combinations of pre-coding matrices.

This prediction using a set of pre-coding matrices, also so-called codebook, advantageously allows determining an optimum pre-coding for the technique that will ultimately be selected. This pre-coding further guarantees compliance with the first criterion for the transmission parameter.

In one embodiment, the selection of the pre-coding matrices comprises at least one iteration of the following steps for a of rank i transmission:
determining a signal-to-interference-plus-noise ratio for each frequency sub-band, based on the pre-coding matrix associated with the rank i transmission for the considered sub-band,
determining an effective signal-to-interference-plus-noise ratio based on the determined signal-to-interference-plus-noise ratios for each sub-band,
determining a modulation and coding scheme based on said effective signal-to-interference-plus-noise ratio and a target error rate, and
estimating the transmission parameter for the rank i transmission, based on the modulation and coding scheme thus determined,
Thus, the receiver can select the combination of pre-coding matrices that maximizes the estimated transmission parameter, for example a bit rate, for the given technique.

Thus, in this embodiment, the selection of an acquisition technique allows optimizing the bit rate offered by this technique. Consequently, this improves the transmission between the emitter and the receiver.

In one embodiment, the given technique is the first technique of the group of techniques, and obtaining the set of pre-coding matrices associated with the first technique for the sub-band k comprises:
determining a channel matrix after whitening the interference, denoted H_{0,k}, such that

$${H}_{0 , k} = {\hat{R}}_{I}^{- \frac{1}{2}} {H}_{k} ,$$

with \hat{R}_{I} the compressed version of the covariance matrix of the interference and Hₖ the matrix representative of the channel on the sub-band k,
determining an input matrix Vₖ derived from the singular value decomposition (SVD) of the channel matrix after whitening the interference H_{0,k}, such that H_{0,k}=UₖΣₖVₖ^{†}, and
constructing said set of pre-coding matrices W̅ₖ^{CSI-R2}, comprising at least one pre-coding matrix wₖ^{v} for a rank ν transmission such that wₖ^{v}=[v₁, . . . vᵥ], with vᵢ the i-th column of said input matrix Vₖ.

The determination of the set of pre-coding matrices associated with the first technique for a frequency sub-band, or, in other words, of the codebook of the CSI-R2 technique, explicitly provides a set of pre-coding matrices among which a pre-coding matrix to be used in the context of the CSI-R2 technique can be selected.

In one embodiment, the set of pre-coding matrices associated with the second technique is predefined by a given standard. In other words, in this embodiment, the technique based on a pre-established pre-coding codebook, CSI-D, is used as the second technique.

In one embodiment, said at least one piece of information relating to the technique for acquiring knowledge of the emission channel selected by said receiver belongs to the group comprising:
said compressed version of said covariance matrix of the interference when the first technique (for example of the CSI-R2 type) is selected;
at least one piece of information from among a channel quality indicator (CQI)—allowing in particular deducing a modulation and coding scheme to be used for the transmission, a rank indicator (RI)—allowing determining the number of spatial layers to be used for the transmission, or a pre-coding indicator (PMI) when the second technique (for example of the CSI-D type) is selected.

The use, as information relating to the selected technique, of a compressed version of the covariance matrix of the interference or of one piece of information among the aforementioned group allows returning to the emitter information that are not voluminous, thereby lightening the communication between the emitter and the receiver.

In one embodiment, the communication method of the development comprises receiving an indicator representative of a compression technique to be implemented to determine said compressed version of the covariance matrix of the interference.

This reception of an indicator allows selecting the compression type on which the first technique for acquiring knowledge of the emission channel is based.

In one embodiment, at least one of said steps of estimating the covariance matrix of the interference, of selecting a technique for acquiring or transmitting at least one piece of information enabling the emitter to determine one pre-coding matrix taking account of the covariance matrix of the interference according to said selected acquisition technique is carried out periodically and/or following a variation of the channel between said emitter and said receiver.

The selection of the acquisition technique, periodically or following a variation of the channel between the emitter, allows maintaining a relevant acquisition technique choice, even though the communication conditions between the emitter and the receiver change.

In one embodiment, the communication method comprises transmitting a reference signal to said emitter.

The transmission of this reference signal (for example of the SRS type, standing for “Sounding Reference Signal”) allows adapting the choice of pre-coding over time. In particular, it may be implemented when the first technique is selected.

The transmission of the reference signal (for example of the SRS type, standing for “Sounding Reference Signal”) may be periodic. Alternatively, the transmission of the reference signal may be aperiodic, and triggered upon reception of a request originating from the emitter.

The development also proposes the communication method implemented at the emitter.

This method according to the development is remarkable in that it comprises:
receiving at least one piece of information originating from the receiver and enabling the emitter to determine a pre-coding matrix taking account of a covariance matrix of the interference, representative of the spatial structure of the reception interference, according to a technique for acquiring knowledge of the emission channel selected by said receiver from among a group of techniques comprising a first technique based on a compressed version of a covariance matrix of the interference and at least one second technique.

In particular, such a method can determine an emission format of the data based on this information (for example defining a pre-coding matrix, a modulation and coding scheme, and/or a number of spatial layers to be used in emission). Afterwards, the method can transmit the data using the emission format thus defined.

In other words, the method can implement an emission technique capable of taking account of the information received by said emitter.

In one embodiment, when said piece of information originating from the receiver is said compressed version of said covariance matrix of the interference, the method implements:
receiving a reference signal originating from said receiver,
estimating a channel between said receiver and said emitter based on said reference signal,
estimating a channel between said emitter and said receiver, based on said estimate of the channel between said receiver and said emitter, by reciprocity,
constructing, for each sub-band of a plurality of frequency sub-bands, a set of pre-coding matrices based on the estimate of the channel between said emitter and said receiver and said compressed version of the covariance matrix of the interference, and
selecting, in each set of pre-coding matrices associated with a sub-band, a pre-coding matrix such that a transmission parameter resulting from this matrix selection meets a criterion, also so-called the second criterion in the description.

In particular, the receiver selects a combination of pre-coding matrices, which, when they are used by the emitter, allow maximizing a transmission parameter, for example a transmission bit rate.

Thus, when the CSI-R2 technique is selected, this communication method is capable of determining the pre-coding to be applied by constructing the codebook of the CSI-R2 technique. This allows implementing the CSI-R2 technique in an efficient manner.

The development also provides a receiver of a transmission system also comprising an emitter, the receiver comprising means for estimating a covariance matrix of the interference, representative of the spatial structure of the reception interference. The receiver further comprises:
means for selecting a technique for acquiring knowledge of the emission channel, in a group of techniques comprising a first technique based on a compressed version of said covariance matrix of the interference and to at least one second technique, and
means for transmitting to said emitter at least one piece of information enabling the emitter to determine a pre-coding matrix taking account of the covariance matrix of the interference according to the technique for acquiring knowledge of the emission channel selected by said receiver.

The development also provides an emitter of a transmission system comprising said emitter and a receiver. The emitter comprises:
means for receiving at least one piece of information originating from the receiver and enabling the emitter to determine a pre-coding matrix taking account of a covariance matrix of the interference, representative of the spatial structure of the reception interference, according to a technique for acquiring knowledge of the emission channel selected by said receiver from among a group of techniques comprising a first technique based on a compressed version of said covariance matrix of the interference and at least one second technique.

The development further provides a computer program including instructions for implementing a method of the previously-described type, when this program is executed by a processor.

### BRIEF DESCRIPTION OF THE DRAWINGS

Other features and advantages of the development will appear more clearly upon reading the following description of a particular embodiment, given as a mere illustrative and non-limiting example, and from the appended drawings, wherein:

FIG. 1 illustrates a transmission system comprising a receiver and an emitter according to an embodiment of the development,

FIG. 2 illustrates the communication method as implemented by a receiver according to an embodiment of the development,

FIG. 3 illustrates an example of a selection step carried out in the communication method of FIG. 2,

FIG. 4 illustrates an example of a prediction step carried out in the selection step of FIG. 3,

FIG. 5 illustrates an example of an estimation step carried out in the prediction step of FIG. 4,

FIG. 6 illustrates an example of a step of obtaining a set of pre-coding matrices carried out in the prediction step of FIG. 4,

FIG. 7 illustrates the communication method as implemented by an emitter according to an embodiment of the development,

FIG. 8 schematically illustrates emitter-receiver exchanges for the CSI-D technique,

FIG. 9 schematically illustrates emitter-receiver exchanges for the CSI-R2 technique in an aperiodic case,

FIG. 10 schematically illustrates emitter-receiver exchanges for the CSI-R2 technique in a periodic case,

FIG. 11 illustrates the simplified structure of a receiver according to an embodiment of the development, and

FIG. 12 illustrates the simplified structure of an emitter according to an embodiment of the development.

### DETAILED DESCRIPTION OF CERTAIN ILLUSTRATIVE EMBODIMENTS

### General Principle

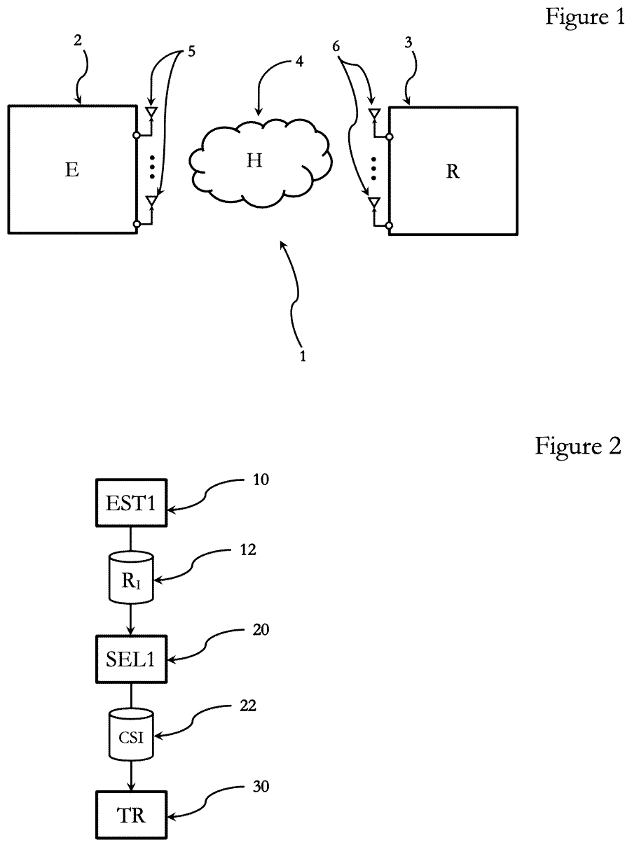

Reference is made to FIG. 1.

A transmission system 1 according to the development comprises an emitter 2 and a receiver 3, in communication via a channel 4. The emitter 2 comprises N_{T} emitter antennas 5 (N_{T}>1). The receiver 3 comprises N_{R} receiver antennas 6 (N_{R}≥1).

The development focuses on the feedback of information from the receiver 3 to the emitter 2, whereby the emitter can implement an emission technique based on the feedback information. More specifically, the development relates to a hybrid approach wherein the receiver assesses several techniques for acquiring knowledge of the emission channel, CSI (“channel state information”), at least one of which is based on a compression of the covariance matrix of the interference.

It is considered that the feedback of a PMI and of an RI by the receiver can take place only in a context where the number of emitter antennas at the emitter is N_{T}>1.

Moreover, it should be noted that the number of spatial layers that a receiver can receive cannot exceed min (N_{T}, N_{R}). In the case of one single receiver antenna at the receiver, the latter can receive only one spatial layer, or in other words RI=1. In the LTE (4G) standard, the number of receiver antennas of a so-called “smartphone” terminal is at least two whereas for the N_{R} standard, the number of receiver antennas for this terminal type is specified to at least four antennas for some bands (3.5 GHz n77/78). For the base stations, the number of emitter antennas has not stopped growing to reach 64 massive MIMO antennas. It should be noted that an antenna in this context is an RF chain including a digital-to-analog conversion and vice versa. Thus, the number of radiating elements may be greater than the number of antennas. If the number of emitter and receiver antennas (or “transceiver units”) is the same at the base station, this is not the case for mobile phones which may have a number of emitter antennas lower than the number of receiver antennas, typically two emitter antennas for four receiver antennas. Nonetheless, the terminal can send reference signals from its four receiver antennas, even in this typical configuration, thanks to the so-called “antenna switching” technique (the RF chain has toggled on another radiating element).

Reference is now made to FIG. 2, which illustrates a communication method according to an embodiment of the development.

The communication method, carried out by the receiver 3, comprises a step EST1 of estimating 10 a covariance matrix of the interference 12, a step SEL1 of selecting 20 a CSI acquisition technique 22 and a step TR of transmitting 30 at least one piece of information relating to said acquisition technique 22 to the emitter 2.

The covariance matrix of the interference 12 estimated during step EST1 is representative of the spatial structure of the reception interference.

In this case, the interference structure refers to the correlation of the interference on the different receiver antennas for a sub-carrier (given frequency) of an OFDM symbol for example. The interference will be so-called “structured” when the covariance matrix of the interference departs from an identity matrix (within a multiplicative factor), i.e., when the correlation between the receiver antennas is strong.

If a receiver with one single receiver antenna is considered, the interference originates for example from the use of several emitter antennas at the emitter.

In this case with one single receiver antenna, the covariance matrix of the interference 12 is a scalar.

If a receiver with several receiver antennas is considered, the covariance matrix of the interference may be representative of the spatial structure of the interference between the receiver antennas.

According to a particular embodiment, step EST1 is based on a configuration of CSI interference measurements (or “CSI interference measurement” in English, also denoted CSI-IM). These CSI-IM indicate positions of resource elements (or RE, standing for “resource element”) where nothing is transmitted by the emitter, which gives a window for measuring the signal-free interference of the emitter 2. In other words, the time-frequency positions (i.e. resource elements) where the covariance should be estimated correspond to zero-power CSI-RSs, i.e. resource elements that are not used for the transmission.

The estimation EST1 may be carried out by correlation of received signals representative of the interference on the different receiver antennas 6, in the absence of reference signals CSI-RS. For example, the emitter 2 can configure resources (in the time-frequency space) prohibited to the transmission (so-called “Zero-Power CSI-RS” technique in the 3GPP ZP-CSI-RS standard TS38.211) which enable the receiver 3 to more easily measure the interference, on these resources and for each receiver antenna 6. Alternatively, it is possible to consider estimating the covariance matrix of the interference 12 based on the subtraction of the useful data or reference signals—i.e. not forming part of the interference from the perspective of the receiver in charge of measuring the latter—to the signals received on each antenna to obtain signals representative of the interference on the different receiver antennas 6.

Step SEL1 of selecting a CSI acquisition technique to be implemented is based on the covariance matrix, conventionally denoted R1, determined beforehand in step EST1. Information relating to the CSI acquisition technique thus selected may be used by said emitter 2 to determine an emission format of the data, when this information is fed back to the emitter, as will be seen hereinafter.

This CSI acquisition technique is selected in a group of techniques comprising a first technique based on a compressed version of said covariance matrix of the interference (in other words, CSI-R2) and at least one second technique. In one embodiment, a second technique is the CSI-D technique. The CSI-D technique may be of the type I or type II, depending on the selection of the codebook. Alternatively, a second technique may be the CSI-R1 technique.

When the CSI-R2 technique is selected, the piece of information relating to CSI-R2 fed back to the emitter 2 is the compressed version of the covariance matrix of the interference, denoted R1. The compression of this matrix may be carried out in several manners.

In one embodiment, the covariance matrix is compressed while retaining only its greatest eigenvalues. Indeed, as the matrix R_{I} is defined positive, it is ortho-diagonalizable (i.e. diagonalizable, and with eigenvectors orthogonal to one another). The eigenvalues of R_{I} are written in the form Sp(R_{I})=(λ₁, . . . , λₙ). All it needs then is to keep the l greatest eigenvalues. Alternatively, it is possible to compress the covariance matrix of the interference such that \hat{R}_{I}=αI_{N}_{_{R}}, by selecting α such that α∈ [symbol] ⁺ minimizes the difference

$${‖ {R}_{I} - {\hat{R}}_{I} ‖}^{2} = tr \{ {( {R}_{I} - {\hat{R}}_{I} )}^{†} ( {R}_{I} - {\hat{R}}_{I} ) \}$$

and belongs to a discrete subset of 2^{q} positive real elements. The compression of the covariance matrix of the interference is thus given by the transmission of q bits from the receiver to the emitter assuming that the discrete subset to which α belongs is known to the emitter and to the receiver as well as the correspondence between the q received bits and the associated value of α.

In one embodiment, the receiver receives (before compression of the covariance matrix of the interference) an indicator representative of the compression technique to be implemented.

When the CSI-D technique is selected by the receiver 3, the receiver 3 feeds back to the emitter 2 (via a limited return path) a pre-coding indicator (PMI) identifying a pre-coding in the pre-coding codebook. The receiver may further feed back a channel quality indicator (CQI)—allowing in particular deducing a modulation and coding scheme to be used for the transmission, and/or a rank indicator (RI)—allowing determining the number of spatial layers to be used for the transmission.

In one embodiment, one amongst the estimation EST1, selection SEL1 or transmission TR steps is carried out periodically and/or following a variation of the channel between said emitter and said receiver.

Thus, according to at least one embodiment, the proposed solution allows taking into account in an optimized manner the structure of the interference, depending on the choice of the technique for acquiring the state of the channel and of the method for compressing the covariance matrix of the interference.

### Selection Criterion

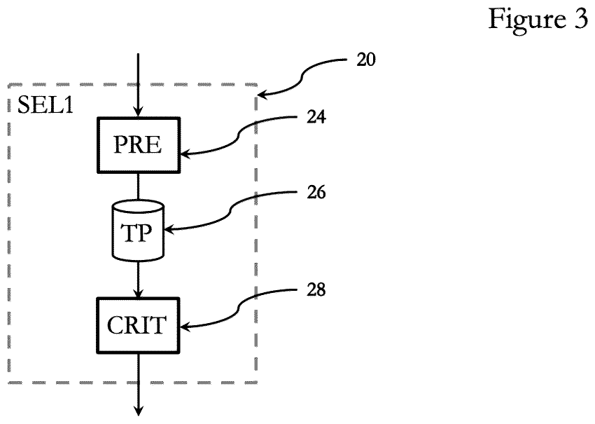

Reference is made to FIG. 3.

In one embodiment, step SEL1 of selecting 20 a CSI acquisition technique comprises a step PRE of predicting 24 a transmission parameter TP 26 associated with each technique (for example CSI-D and CSI-R2) of the group of techniques. Afterwards, in a step CRI, referenced 28, the technique to be implemented is selected based on a first criterion relating to the predicted transmission parameter TP.

In a particular embodiment, the predicted transmission parameter for a given acquisition technique is a bit rate, that this technique allows reaching. In this case, the first criterion is the maximization of this bit rate. Alternatively, the first criterion may consist in reaching a target bit rate, and, if the two techniques offer this target bit rate, then selecting the most efficient technique in terms of bandwidth.

In other embodiments, this transmission parameter is a signal-to-noise ratio (SNR), a signal-to-noise-plus-interference ratio (SINR), an error rate, an interference margin, a payload rate, etc.

### General Principle of the Prediction of the Transmission Parameter

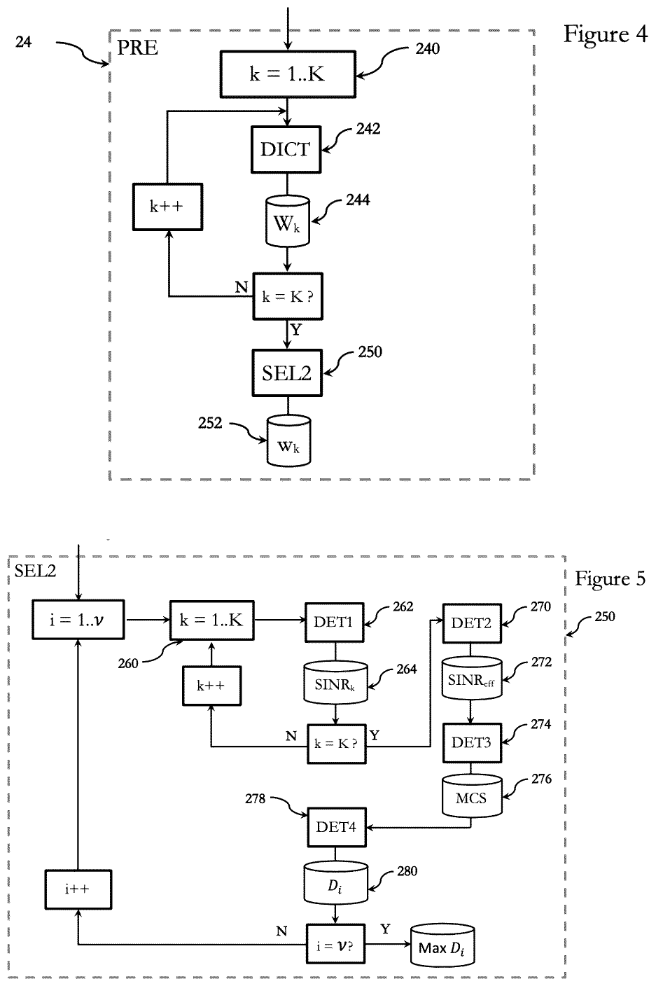

Reference is made to FIG. 4.

In one embodiment, the prediction 24 of the transmission parameter associated with a given technique (CSI-R2, CSI-D) comprises:
an iteration loop 240, each iteration of which comprises a step DICT of obtaining 242 codebooks 244 for each sub-band k of a plurality of frequency sub-bands of the channel 4, and
a step SEL2 of selecting 250, in each set of pre-coding matrices associated with a sub-band k, a pre-coding matrix wₖⁱ 252, so that the transmission parameter TP resulting from this selection meets a second criterion.

Each iteration loop 240 comprises a step DICT of obtaining 242 a set of pre-coding matrices 244, also so-called a codebook of the given CSI technique and denoted W̅ₖ^{CSI}, for said sub-band k. The iteration loop ends by verifying whether the iteration comes to the end of the plurality of sub-bands. If this is not the case, we return to the beginning of the loop by incrementing the sub-band index.

Obtaining 242 the codebook may be carried out either by constructing a codebook related to the given technique (for example for CSI-R2, as will be seen hereinafter), or by obtaining a predetermined codebook, typically defined by a standard.

Once these codebook W̅ₖ^{CSI} obtained for each sub-band k, the pre-coding matrices wₖⁱ (one per sub-band) are selected in step SEL2 such that the transmission parameter TP resulting from this selection meets a second criterion.

For example, the pre-coding matrices of the same rank are selected allowing maximizing a bit rate type transmission parameter, as described hereinafter.

### Prediction of the Bit Rate

Reference is made to FIG. 5.

In one embodiment described herein, the transmission parameter to be predicted for the given technique is the bit rate met by the given technique.

In this case, the selection SEL2 comprises at least one iteration of the following steps for a rank i transmission, i∈{0, . . . , ν}:
a step DET1 of determining 262 a signal-to-interference-plus-noise ratio 264 (SINR) for each frequency sub-band k, denoted SINRₖ or γₖ, from the pre-coding matrix associated with the rank i transmission for the considered sub-band.
a step DET2 of determining 270 an effective signal-to-interference-plus-noise ratio SINR_{eff} 272 for the given technique from the signal-to-interference-plus-noise ratios determined for each sub-band k∈{0, . . . , K},
a step DET3 of determining 274 a modulation and coding scheme MCS, referenced 276, from said effective SINR 272 and a target error rate,
a step DET4 of estimating 278 the transmission parameter for the i rank transmission, for example a bit rate Di, referenced 280, complied with by the given technique from the modulation and coding scheme thus determined.

When all of the combinations of pre-coding matrices associated with the different rank values are tested, the receiver has a set of bit rate values Dᵢ, and can select the combination of decoding matrices associated with the maximum bit rate Dᵢ.

For illustration, the SINR of a LMMSE-IRC type linear receiver, for a sub-band k and a rank i transmission, may be expressed in the form hereinbelow:

$${γ}_{k}^{i} ( {w}_{l , k}^{i} , {H}_{k} , {R}_{I} ) = \frac{{g}_{i}}{1 - {g}_{i}} ∀ i ∈ \{ 1 , … , v \}$$

where w_{l,k}ⁱ, Hₖ, R_{I} are respectively a pre-coding matrix for a rank i transmission on the sub-band k and on a resource element l, the channel matrix of the sub-band k and the covariance matrix. As regards gᵢ, it is defined by the expression hereinafter (where eᵢ is the i-th vector with the dimension ν of the canonical basis, i.e. a vector with a coordinate 1 at the position i, and 0 elsewhere):

$${g}_{i} = {e}_{i}^{†} {σ}_{x}^{2} {w}_{l , k}^{†} {{H}_{k}^{†} ( {σ}_{x}^{2} {w}_{l , k}^{†} {H}_{k}^{†} {H}_{k} {w}_{l , k} + {R}_{I} )}^{- 1} {e}_{i}$$

The effective SINR is determined based on the SINRs of each sub-band, via a MIESM (“mutual information effective signal-to-noise-ratio mapping”) compression.

Thanks to a technique for abstraction of the physical layer, as disclosed in particular in the documents “Link performance models for system level simulations of broadband radio access systems” (K. Brueninghaus et al., IEEE 16th Int. Symposium on Personal, Indoor and Mobile Radio Communications, 2005 (PIMRC 2005), vol. 4, 2005, pp. 2306-2311) or “Realistic Performance of LTE: In a Macro-Cell Environment” (B. Landre et al. Proc. IEEE VTCS-2012, Japan, Yokohama, May 2012), a modulation and coding scheme can be determined based on this effective SINR and a target error rate using Gaussian quality tables.

These Gaussian quality tables allow empirically relating the effective SINR, a target BLER error rate and a modulation and coding scheme. The modulation and coding scheme, denoted MCS, allows calculating a bit rate. This bit rate is determined based on the modulation (number of bits per symbol) and of the “coding rate” (ratio of useful bits). In one embodiment, a target BLER error rate is set at 10% (or more generally at less than 20%), which allows deducing the modulation and coding scheme to be used, knowing the effective SINR. This then allows obtaining a rate for the selected technique.

Alternatively, the transmission parameter may be the effective SINR, or the BLER error rate. In the case where the transmission parameter is the effective SINR, the prediction step stops at the step delivering the effective SINR (DET2). In the case where the transmission parameter is the BLER error rate, the prediction step stops at the step delivering the modulation and coding scheme (DET3).

In one embodiment, the receiver 3 determines a CQI based on the MCS, and transmits the determined CQI to the emitter 2.

### Codebook for CSI-R2

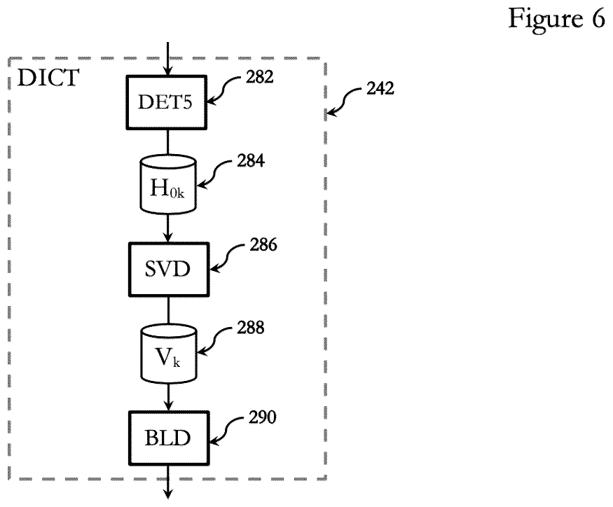

Reference is made to FIG. 6.

In the embodiment described herein, the technique whose transmission parameter (not necessarily the bit rate) is to be predicted is the first technique, or, in other words, CSI-R2.

In this case, obtaining of CSI-R2 codebook (W̅ₖ^{CSI-R2}) for a frequency sub-band k comprises a step DET5 of determining 282 a channel matrix after whitening of the interference (referenced 284 and denoted H_{0,k}), a step SVD of determining 286 an input matrix (referenced 288 and denoted Vₖ) and a step BLD of constructing 290 the CSI-R2 codebook 292.

In the case of CSI-R2, it is known that the emitter 2 can know the channel matrix Hₖ (by reciprocity) but not the covariance matrix of the interference R_{I}. This prevents the emitter from working with the complete and “exact” model based on Hₖ and R_{I}. Hence, the emitter can work only on a simplified model, in which the matrix R_{I} is replaced by its compressed equivalent \hat{R}_{I}. A pre-coding codebook that both the emitter and the receiver can obtain from the information at their disposal, namely \hat{R}_{I} and Hₖ, should be constructed. This is the role of the steps described hereinafter.

The channel matrix after whitening of the interference meets the equation H_{0,k}H_{0,k}^{†}=Hₖ^{†}\hat{R}_{I}Hₖ. Therefore, the matrix H_{0,k} is determined according to the following equation:

$${H}_{0 , k} = {\hat{R}}_{I}^{- 1 / 2} {H}_{k}$$

where \hat{R}_{I} is the compressed version of the covariance matrix of the interference and Hₖ the matrix representative of the channel on the given frequency sub-band k.

After whitening of the interference, the model of the signal received on a resource element l of the frequency sub-band k may be expressed in the following form:

$${y}_{l , k} = {\hat{R}}_{I}^{- 1 / 2} {H}_{k} {\tilde{x}}_{l , k} + {n}_{l , k} = {H}_{0 , k} {\tilde{x}}_{l , k} + {n}_{l , k}$$

with [symbol] {n_{l,k}n_{l,k}^{†}}=I_{N}_{_{R}} where N_{R} the number of receiver antennas 6 and \tilde{x}_{l,k} the pre-coded data vector.

Once the matrix H_{0,k} has been obtained, a decomposition into singular values (also called SVD, “singular value decomposition” in English) is carried out. This consists in decomposing the matrix H_{0,k} as follows:

$${H}_{0 , k} = {U}_{k} {\sum }_{k} {V}_{k}^{†}$$

The matrix Vₖ is so-called the input matrix (and Vₖ^{†} its conjugate transpose matrix), the matrix Uₖ is so-called the output matrix, and the diagonal matrix Σₖ contains in its diagonal coefficients the singular values of the matrix H_{0,k}, or, in other words, the square roots of the eigenvalues of the matrix H_{0,k}H_{0,k}^{†}. The matrix Σₖ is in the form Σₖ=diag(λ₁, . . . , λ_{N}_{_{R}}) where N_{R} is the number of receiver antennas 6, the diagonal coefficients λ₁, . . . , λ_{N}_{_{R}} being decreasing.

Afterwards, the codebook of the CSI-R2 technique is constructed as follows considering that the number of spatial layers ν, also so-called rank, is lower than or equal to the number of receiver antennas (ν≤N_{R}):
for a given number of spatial layers ν (for the sub-band k), the eigenvector vᵢ of H_{0,k}H_{0,k}^{†} is noted associated with the eigenvalue λᵢ,
the pre-coding matrix wₖ^{ν} for ν spatial layers is defined in this manner: wₖ^{ν}=[v₁, . . . , v_{ν}], and
the pre-coding codebook W̅ₖ^{CSI-R2} is defined as follows: W̅ₖ^{CSI-R2}=(wₖ¹, . . . , wₖ^{N}^{_{R}}).

Thus, considering a distribution of the power equi-distributed between the spatial layers, and that the spatial layers are independent, the pre-coded signal to be transmitted may be written as follows \tilde{x}ₖ=wₖ^{ν}xₖ with xₖ the vector representing the ν spatial layers to be transmitted on a resource element such that [symbol] {xₖxₖ^{†}}=σₓ²I_{ν}.

By noting Pₘₐₓ the maximum power per emitter antenna (“Transceiver unit” or TXRU), it arises that the maximum power per spatial layer meets the equation

$${σ}_{x}^{2} = {min}_{t ∈ \{ 1 , … , {N}_{T} \}} \frac{{P}_{max}}{{[ {{w}_{k}^{v} ( {w}_{k}^{v} )}^{†} ]}_{t , t}} .$$

Alternatively, the content of the pre-coding codebook may differ.

For example, in the case of a “Water Filling” type power allocation strategy, with an overall power constraint (i.e. the powers are optimized by spatial layer and no longer by emitter antenna), then the optimum transmission is done for a rank equal to the number of antennas of the receiver, and in this case, the codebook is in the form W̅ₖ^{CSI-R2}=(wₖ^{N}^{_{R}}).

### Codebook for CSI-D

In the case of CSI-D, the pre-coding codebook W̅ₖ^{D} for a frequency sub-band k is predefined by a given standard. For example, obtaining the CSI-D codebook (W̅ₖ^{D}) implements reading a table defined in the considered standard.

### General Principle of the Communication Method Implemented by the Emitter

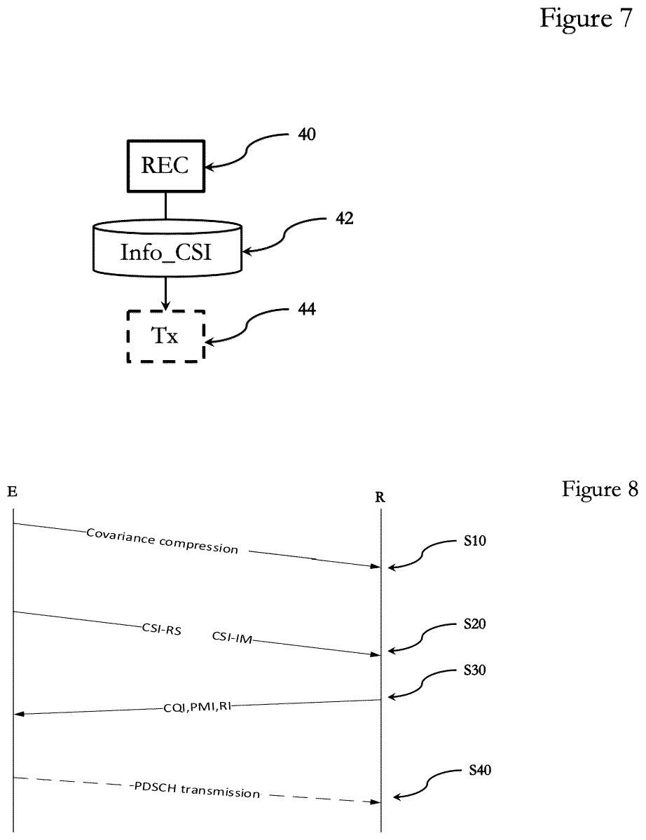

Reference is made to FIG. 7.

A communication method according to the development comprises a step 40 of receiving, by the emitter, originating from a receiver, a piece of information 42 relating to an acquisition technique selected by the receiver 3.

For example, such a piece of information 42 may be used to define an emission format to be used by the emitter (for example a pre-coding matrix, a modulation and coding scheme and/or a number of spatial layers).

In one embodiment, the communication method also comprises the emission 44 of data using the emission format defined based on said received piece of information 42.

In one embodiment, the information originating from the receiver is the compressed version of the covariance matrix of the interference \hat{R}_{I} (when the receiver 3 selects the CSI-R2 method).

In this case, the communication method comprises:
receiving a reference signal originating from the receiver,
estimating the channel matrix between the receiver and the emitter based on this reference signal,
estimating a channel between said emitter and said receiver, based on said estimation of the channel between said receiver and said emitter, by reciprocity of the channel,
constructing, for each sub-band of a plurality of sub-bands, a set of pre-coding matrices based on the estimation of the channel between said emitter and said receiver and of said compressed version of the covariance matrix of the interference,
selecting, in each set of pre-coding matrices associated with a sub-band, a pre-coding matrix such that a transmission parameter resulting from this selection meets the second criterion.

The reference signal may be an SRS (“Sounding Reference Signal” in English) type signal. The step of receiving this reference signal may be carried out on a regular basis or on request, as will be seen hereinafter.

In another embodiment, the piece of information originating from the receiver is at least one piece of information from among a channel quality indicator (CQI), a rank indicator (RI), a pre-coding indicator (PMI)—for example if the receiver 3 selects the CSI-D method In this case, the communication method comprises:
emitting a reference signal, for example of the CSI-RS type, enabling in particular the receiver to estimate the channel in the emitter-to-receiver direction,
identifying a pre-coding matrix to be used by the emitter, based on the piece of information originating from the receiver (CQI, RI and/or PMI).

### Periodicity and Aperiodicity

In one embodiment, one of the estimation EST1, selection SEL1 or transmission TR steps implemented by the receiver is carried out periodically and/or aperiodically, for example following a variation of the channel between said emitter and said receiver.

In the latter case (so-called aperiodic), this may be done on request of the emitter 2 to the receiver 3.

In the periodic case, the receiver 3 may in particular emit on a regular basis a reference signal to the emitter 2, for example of the SRS (“Sounding Reference Signal” in English) type.

In the aperiodic case, the receiver 3 may emit a reference signal upon reception of a request from the emitter 2, for example of the “SRS trigger command” type.

Reference is made to FIGS. 8 to 10, which schematically represent an order of exchanges between the receiver and the emitter.

In FIGS. 8 to 10, the exchanges between the emitter 2 and the receiver 3 (herein denoted E and R, respectively) may comprise, in that order:
S10 (E to R) sending (optional) an instruction on the method for compressing the covariance to be used for the receiver. In particular, the compression method may be configured by the RRC layer in a semi-static manner,
S20 (E to R) sending CSI-RS and CSI-IM signals, so that the receiver 3 could estimate the covariance matrix and the channel matrix. These signals may be transmitted periodically or aperiodically,
S30 (R to E) sending the piece of information relating to the technique selected by the receiver,
S40 (E to R) implementing the emission format, in particular the pre-coding, defined based on the piece of information relating to the technique selected by the receiver.

The receiver may then implement the previously-described communication method, and in particular the selection of a technique for acquiring knowledge of the emission channel.

In the embodiment illustrated in FIG. 8, it is assumed that the technique selected by the receiver 3 is of the CSI-D type.

The following steps may then be implemented:
S30 (R to E) sending the piece of information relating to the technique selected by the receiver (herein CSI-D, the piece of information then comprising the PMI, and possibly CQI and RI),
S40 (E to R) implementing the emission format, in particular the pre-coding, defined based on the piece of information relating to the technique selected by the receiver (herein, CSI-D, the information being a PMI identifying the pre-coding to be implemented).

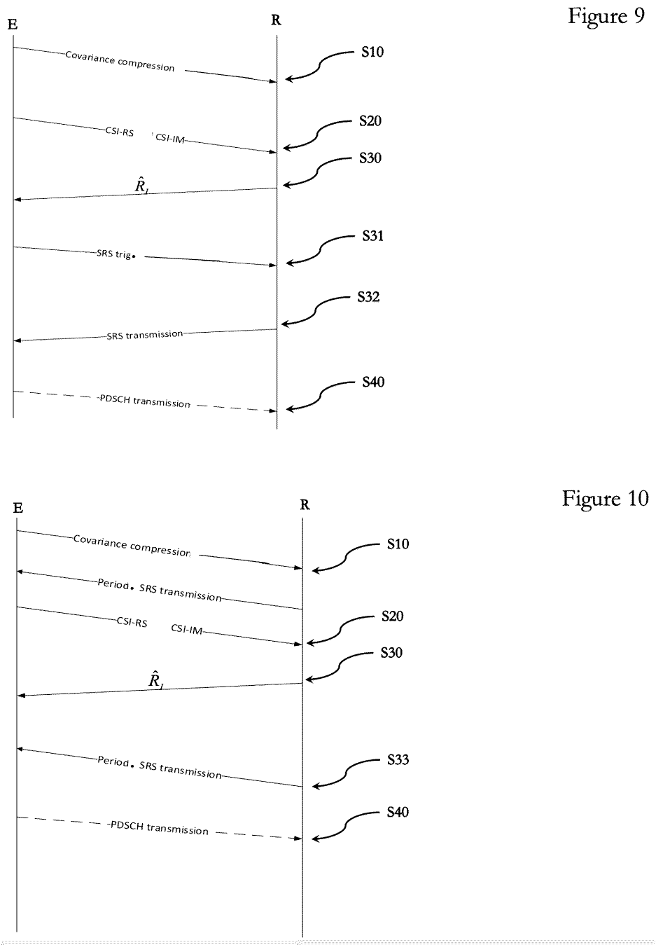

In the embodiment illustrated in FIG. 9, it is assumed that the technique selected by the receiver 3 is of the CSI-R2 type. It is also assumed that the receiver transmits a reference signal SRS aperiodically, for example in response to a request of the emitter.

In this case, the following steps may be implemented:
S30 (R to E) sending the piece of information relating to the technique selected by the receiver (herein CSI-R2, the piece of information being the compressed version of the covariance matrix of the interference \hat{R}_{I}, compressed according to the method M indicated by the emitter, where appropriate),
S31 (E to R) requesting (from the emitter) a transmission of a reference signal SRS
S32 (R to E) emitting a reference signal SRS (used for channel estimation by the emitter), in response to the request of step S31
S40 (E to R) implementing the emission format, in particular the pre-coding, defined based on the piece of information relating to the technique selected by the receiver (herein, CSI-R2, and the implemented pre-coding is determined based on the compressed version of the covariance matrix of the interference and on the estimated channel matrix thanks to the reference signal SRS).

In the embodiment illustrated in FIG. 10, it is assumed that the technique selected by the receiver 3 is also of the CSI-R2 type. It is also assumed that the receiver transmits a reference signal SRS periodically.

The exchanges between the emitter 2 and the receiver 3 are similar to those of the aperiodic case shown in FIG. 9, with the exception of steps S31 and S32 which are replaced by a step S33:
S33 (R to E) emission of a reference signal SRS (used for channel estimation by the emitter), periodically.

In the embodiments illustrated in FIGS. 9 and 10, the emitter may use the most recent reference signal SRS to estimate the channel.

### Devices

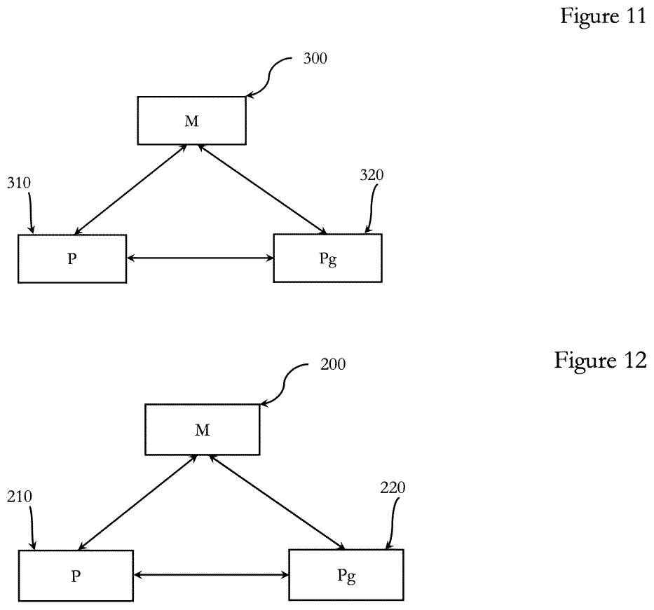

Finally, referring to FIGS. 11 and 12, the simplified structures of a receiver and of an emitter according to an embodiment of the development are described.

As illustrated in FIG. 11, a receiver 3 according to an embodiment of the development comprises a memory 300, a processing unit 310, equipped for example with a programmable computing machine or a dedicated computing machine, for example a processor P, and controlled by the computer program 320, implementing steps of the communication method according to at least one embodiment of the development.

Upon initialization, the code instructions of the computer program 320 are for example loaded into a RAM memory before being executed by the processor of the processing unit 310.

The processor of the processing unit 310 implements steps of the above-described communication method, according to the instructions of the computer program 320, to:
estimate a covariance matrix of the interference, representative of the spatial structure of the reception interference,
select a technique for acquiring knowledge of the emission channel, in a group of techniques comprising a first technique based on a compressed version of said covariance matrix of the interference and at least one second technique, and
transmit to said emitter a piece of information relating to said technique for acquiring knowledge of the emission channel selected by said receiver.

As illustrated in FIG. 12, an emitter according to an embodiment of the development comprises a memory 200, a processing unit 210, equipped for example with a programmable computing machine or a dedicated computing machine, for example a processor P, and controlled by the computer program 220, implementing steps of the communication method according to at least one embodiment of the development.

Upon initialization, the code instructions of the computer program 220 are for example loaded into a RAM memory before being executed by the processor of the processing unit 210.

The processor of the processing unit 210 implements steps of the above-described communication method, according to the instructions of the computer program 220, to:
receive at least one piece of information originating from the receiver and relating to a technique for acquiring knowledge of the emission channel selected by said receiver from among a group of techniques comprising a first technique based on a compressed version of a covariance matrix of the interference, representative of the spatial structure of the reception interference, and at least one second technique.

1. A communication method implemented in a transmission system comprising an emitter and a receiver, the receiver implementing:
estimating a covariance matrix of the interference, representative of the spatial structure of the reception interference,
characterized in that the receiver further implements:
selecting a technique for acquiring knowledge of the emission channel, in a group of techniques comprising a first technique based on a compressed version of said covariance matrix of the interference and at least one second technique, and
transmitting to the emitter at least one piece of information enabling the emitter to determine a pre-coding matrix taking account of the covariance matrix of the interference according to the technique for acquiring knowledge of the emission channel selected by the receiver.

2. The method according to claim 1, characterized in that the selection of a technique for acquiring knowledge of the emission channel comprises the prediction of a transmission parameter associated with each technique of the group of techniques and the selection of the technique for which the transmission parameter meets a first criterion.

3. The method according to claim 2, characterized in that the prediction of the transmission parameter associated with a given technique of the group of techniques comprises:
for each sub-band k of a plurality of frequency sub-bands of the channel between the emitter and the receiver, obtaining a set of pre-coding matrices (W _k\hat{ }(CSI-R2), W _k\hat{ }D), and
selecting, in each set of pre-coding matrices associated with a sub-band, a pre-coding matrix so that the transmission parameter resulting from this selection meets a second criterion.

4. The method according to claim 3, characterized in that the selection of the pre-coding matrices comprises at least one iteration of the following steps for a rank i transmission:
determining a signal-to-interference-plus-noise ratio for each frequency sub-band, based on the pre-coding matrix associated with the rank i transmission for the considered sub-band,
determining an effective signal-to-interference-plus-noise ratio based on the determined signal-to-interference-plus-noise ratios for each sub-band,
determining a modulation and coding scheme based on the effective signal-to-interference-plus-noise ratio and a target error rate, and
estimating the transmission parameter for the rank i transmission, based on the modulation and coding scheme thus determined,
and in that the selected pre-coding matrices maximize the estimated transmission parameter.

5. The method according to claim 3, characterized in that the given technique is the first technique of the group of techniques, and in that obtaining the set of pre-coding matrices (W _k\hat{ }(CSI-R2)) associated with the first technique for the sub-band k comprises:
determining a channel matrix after whitening the interference, denoted H_(0,k), such that H_(0,k)=R\hat{ }_I\hat{ }(−1/2) H_k, with R\hat{ }_I the compressed version of the covariance matrix of the interference and H_k the matrix representative of the channel on the sub-band k,
determining an input matrix V_k derived from the singular value decomposition (SVD) of the channel matrix after whitening the interference H_(0,k), such that H_(0,k)=U_k Σ_k V_k\hat{ }†, and
constructing the set of pre-coding matrices (W _k\hat{ }(CSI-R2)), comprising at least one pre-coding matrix w_k\hat{ }v for a rank ν transmission such that w_k\hat{ }v=[v_1, . . . v_v], with v_i the i-th column of the input matrix V_k.

6. The method according to claim 3, characterized in that the set of pre-coding matrices (W _k\hat{ }D) associated with the second technique is predefined by a given standard.

7. The method according to claim 1, characterized in that the at least one piece of information enabling the emitter to determine a pre-coding matrix taking account of the covariance matrix of the interference according to the technique for acquiring knowledge of the emission channel selected by the receiver belongs to the group comprising:
the compressed version of the covariance matrix of the interference when the first technique is selected;
at least one piece of information from among a channel quality indicator (CQI), a rank indicator (RI), a pre-coding indicator (PMI).

8. The method according to claim 1, characterized in that it comprises receiving an indicator representative of a compression technique to be implemented to determine the compressed version of the covariance matrix of the interference.

9. The method according to claim 1, characterized in that at least one of the steps of estimating the covariance matrix of the interference, selecting a technique for acquiring or transmitting at least one piece of information enabling the emitter to determine a pre-coding matrix taking account of the covariance matrix of the interference according to the selected acquisition technique is carried out periodically and/or following a variation of the channel between the emitter and the receiver.

10. The method according to claim 1, further comprising transmitting a reference signal to the emitter.

11. A communication method implemented in a transmission system comprising an emitter and a receiver, characterized in that the emitter implements:
receiving at least one piece of information originating from the receiver and enabling the emitter to determine a pre-coding matrix taking account of a covariance matrix of the interference, representative of the spatial structure of the reception interference, according to a technique for acquiring knowledge of the emission channel selected by the receiver from among a group of techniques comprising a first technique based on a compressed version of the covariance matrix of the interference and at least one second technique.

12. The method according to claim 11, characterized in that when the piece of information originating from the receiver is the compressed version of the covariance matrix of the interference, the emitter implements:
receiving a reference signal originating from the receiver,
estimating a channel between the receiver and the emitter based on the reference signal,
estimating a channel between the emitter and the receiver, based on the estimate of the channel between the receiver and the emitter, by reciprocity,
constructing, for each sub-band of a plurality of sub-bands, a set of pre-coding matrices based on the estimate of the channel between the emitter and the receiver and the compressed version of the covariance matrix of the interference,
selecting, in each set of pre-coding matrices associated with a sub-band, a pre-coding matrix such that a transmission parameter resulting from this selection meets a criterion, so-called a second criterion.

13. A receiver of a transmission system also comprising an emitter, the receiver comprising means for estimating a covariance matrix of the interference, representative of the spatial structure of the reception interference,
characterized in that the receiver further comprises:
means for selecting a technique for acquiring knowledge of the emission channel, in a group of techniques comprising a first technique based on a compressed version of the covariance matrix of the interference and at least one second technique, and
means for transmitting to the emitter at least one piece of information enabling the emitter to determine a pre-coding matrix taking account of the covariance matrix of the interference according to the technique for acquiring knowledge of the emission channel selected by the receiver.

14. An emitter of a transmission system comprising the emitter and a receiver, characterized in that the emitter comprises:
means for receiving at least one piece of information originating from the receiver and enabling the emitter to determine a pre-coding matrix taking account of a covariance matrix of the interference, representative of the spatial structure of the reception interference, according to a technique for acquiring knowledge of the emission channel selected by the receiver from among a group of techniques comprising a first technique based on a compressed version of the covariance matrix of the interference and at least one second technique.

15. A computer program including instructions for implementing a method according to claim 1 when this program is executed by a processor.
